(19) United States
(12) Patent Application Publication
(10) Pub. No.: US 2011/0280036 A1
(43) Pub. Date: Nov. 17, 2011

(54) LIGHT GUIDE MODULE AND MANUFACTURING METHOD THEREOF

(75) Inventor: Te-Hsin Yi, Taipei City (TW)

(73) Assignee: AQUA-TECH OPTICAL CORPORATION, Sindian City (TW)

(21) Appl. No.: 12/778,752

(22) Filed: May 12, 2010

(51) Int. Cl. G02B 6/00; G02B 6/10

(52) U.S. Cl. 362/551; 264/1.29

(57) ABSTRACT

A light guide module includes an elongated bar-shaped light guide member, a light emitting assembly mounted to at least one end of the light guide member, and a reflector partially covering the light guide member and the light emitting assembly. The light guide member has an axially extended hollow bore and a light-guiding structure formed in the hollow bore. The light emitting assembly includes a circuit board shaped corresponding to a cross-sectional shape of the light guide member, at least one light-emitting unit mounted on one face of the circuit board adjacent to the light guide member, and a light-shielding unit extended into the hollow bore. The reflector has one open or light-transmitting side to serve as a light projection side. With the above arrangements, the light guide module can be miniaturized and the light-shielding unit helps in solving the problem of uneven light intensity at the light projection side.

### FIELD OF THE INVENTION

The present invention relates to a light guide module and manufacturing method thereof, and more particularly to a miniaturized light guide module capable of providing light with even luminous intensity and to a method of manufacturing the light guide module.

### BACKGROUND OF THE INVENTION

In recent years, due to its advantages of compactness, low power consumption and low radiation, the liquid crystal display (LCD) device has been widely applied in various kinds of consumer electronic products, such as mobile phones, personal digital assistants (PDAs), notebook computers, digital cameras, computer screens, and flat panel televisions. That is why people pay special attention to the image quality of the LCD device.

Generally speaking, a non-self-luminous LCD device displays an image by providing light from a backlight module to an LCD panel of the LCD device. Therefore, the performance of the backlight module, including the color gamut, the luminance and the light evenness thereof, has very great influence on the image quality of the LCD device. A light guide module is one of many prerequisite elements of the backlight module. Further, since light-emitting diodes (LEDs) have gradually replaced the conventional cold cathode fluorescent lamp (CCFL) for use as a backlight source in the light guide module, the backlight module can be more flexibly designed.

In the conventional light guide module, a linear light source emitted from a turned-on lamp is reflected by a reflector to enter into a light guide plate. The linear light source will be totally reflected back internally and scattered between an upper and a lower side of the light guide plate. Meanwhile, light that is not totally reflected back internally but passes through the light guide plate is reflected back into the light guide plate again by the reflector for use. When the upper side of the light guide plate is destructed to lose the condition for total internal reflection, the linear light source will be converted by the light guide plate into area light source with uniform luminance. The area light source is then diffused by a diffusion sheet and collected via a prism sheet to thereby have enhanced brightness and evenness. By providing a protective film on the light guide module at a predetermined position, the bright and even area light source is diffused and projects outward via only one side of the light guide plate to uniformly distribute in an illuminating zone.

However, the conventional light guide module in a fully assembled state has large volume and thickness, which does not meet the current requirements for compactness and low profile. Further, light projected from two opposite ends of the light guide module usually has light intensity larger than other areas to cause the problem of unevenly projected light. Moreover, the conventional light guide module usually has light-guiding unit and light-reflecting unit that are produced by injection molding and have fixed sizes. Multiple molds must be made to produce differently sized light guide modules, which would inevitably increases the manufacturing cost of the light guide modules. Therefore, it is necessary to improve the conventional light guide module.

### SUMMARY OF THE INVENTION

A primary object of the present invention is to provide a miniaturized light guide module that enables light sources emitted from two ends of the light guide module to irradiate on an internal light-guiding structure and then evenly project outward via a light projection side to provide light with even luminous intensity.

Another object of the present invention is to provide a method of manufacturing a miniaturized light guide module capable of providing light with even luminous intensity.

To achieve the above and other objects, the light guide module according to a preferred embodiment of the present invention includes a light guide member, at least one light emitting assembly, and a reflector. The light guide member is in the form of an elongated bar, which is internally provided with a hollow bore extended from a first end to an opposing second end thereof, and a light-guiding structure is provided in the hollow bore for changing the light propagating through the hollow bore to different projection directions.

According to a user's requirement, the elongated bar of the light guide member can have a cross section in a round, square, rectangular, oval, pyramid or polygonal shape or any combination thereof; and the hollow bore can also have a cross section in a round, square, rectangular, oval, pyramid or polygonal shape or any combination thereof.

The light-guiding structure can be a spirally extended destructive notch. In the case two light emitting assemblies are separately provided on two opposite ends of the light guide member, the destructive notch has a depth gradually increasing from the two ends of the elongated bar toward a middle portion thereof. In the case the light guide member has only one light emitting assembly provided on the first end thereof, the destructive notch shall have a depth gradually increasing from the first end toward the second end of the elongated bar.

The light emitting assembly is provided on at least one of two ends of the elongated bar of the light guide member. The light emitting assembly includes a circuit board having a shape corresponding to the cross-sectional shape of the elongated bar. The circuit board is provided on one face adjacent to the end of the elongated bar with a light-emitting unit for emitting light toward the light-guiding structure and a light-shielding unit sidewardly extended into part of the hollow bore.

The reflector includes a reflective plate covering part of an exterior of the light guide member and the light emitting assemblies, such that an open side of the reflective plate that does not cover the light guide member and the reflector forms a light projection side via which light is guided outward. In a preferred embodiment, the reflective plate is in the form of a substantially U-sectioned channel structure having three sides covering three outer surfaces of the light guide member and the light emitting assemblies and a fourth side forming into an opening to serve as the light projection side. A light-transmitting structure can be integrally formed with the U-sectioned channel structure at the opening thereof. Alternatively, a light-transmitting plate can be further provided for attaching to a top of the substantially U-sectioned channel structure to cover the opening thereof.

For the destructive notch to achieve the effect of forming light with even luminous intensity, the spirally extended notch can be designed to have fixed pitch or variable pitch. The size of the pitch is determined according to the luminance of the light-emitting units and the length of the elongated bar of the light guide member.

The circuit board of each of the light emitting assemblies can be further provided at a central portion with a wiring hole communicating with the hollow bore in the elongated bar, so that the circuit board located at one end of the light guide member can be connected to the circuit board located at the opposing end by wires extended through the wiring holes. And, in the event a length-increased light guide module is needed, a plurality of adjoining light guide modules can be serially connected by extending multiple wires through the wiring holes and the hollow bores to electrically connect the circuit boards on these light guide modules to one another in series.

To achieve the above and other objects, the method of manufacturing a light guide module according to the present invention includes the following steps: producing an elongated bar-shaped hollow light guide member; producing a light-guiding structure in the light guide member; providing a light-emitting unit and a light-shielding unit on a circuit board to form a light emitting assembly; mounting the light emitting assembly to at least one of two ends of the light guide member and orienting the light-emitting unit toward the light-guiding structure for emitting light; producing an elongated reflector; and covering the reflector on an exterior of the light emitting assembly and the light guide member to complete a light guide module having one single light projection side.

According to the present invention, the light guide member and the reflector are produced using an extruder through vacuum suction forming. The vacuum suction forming includes the following steps: feeding a plastic material into the extruder so as to decompose and dry any water contained in the plastic material; using a screw rod in the extruder to convey the dried plastic material to an extruding mould; under an action of a sealed vacuum tank, the dried plastic material in the extruding mould being moved into a sizing cage and then molded to a specific form via vacuum suction forming; passing the plastic material molded via vacuum suction forming to a cooling tank, so as to fully cool the plastic material; and using a pulling unit to pull the molded and cooled plastic material out of the extruding mould and then, trimming and cutting the molded plastic material into an elongated hollow bar.

In a preferred embodiment, the reflector produced through the vacuum suction forming is further cut at one side to form an opening, so that the opening serves as a light projection side of the reflector; the light-guiding structure is produced on the light guide member by laser engraving or printing; and the light guide member can be further formed into other special geometric shapes by way of hot press molding, so that the light-guiding structure is also hot press molded into a geometric shape.

In another preferred embodiment, the reflector formed via the vacuum suction forming is a dual-structure elongated hollow bar with one side of which formed into a light-transmitting structure and another three side of which formed into a light-reflecting structure, so that the side with the light-transmitting structure forms the light projection side of the reflector.

The light guide module of the present invention is characterized in that two light emitting assemblies can be provided to two ends of the light guide member for emitting light toward the spirally extended destructive notch in the light guide member, and the reflector covers three sides of the light guide member and the light emitting assembly with an open side of the reflector serving as a light projection side. With these arrangements, a miniaturized light guide module is formed. Further, with the light-shielding units of the light emitting assemblies extended into two end portions of the light guide member, the light sources emitted from the two light emitting assemblies toward the light guide member can be projected outward via the light projection side of the light guide module at even luminous intensity. Therefore, the problem in the conventional light guide module of having high luminous intensity at two ends and low luminous intensity at a middle portion of the light guide module can be effectively improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a light guide module according to a first preferred embodiment of the present invention;

FIG. 2 is an exploded view of FIG. 1;

FIG. 3 is a sectioned side view of FIG. 1;

FIG. 4 is similar to FIG. 3 but having only one light emitting assembly provided to one end of the light guide module;

FIG. 5 illustrates several different cross-sectional shapes for a light guide member of the light guide module of the present invention;

FIG. 6 illustrates several different cross-sectional shapes for a reflector of the light guide module of the present invention;

FIG. 7 shows the provision of a light-transmitting plate on a light projection side of the reflector of the light guide module of the present invention;

FIG. 8 is an enlarged fragmentary sectional view showing the manner in which light is guided to project outward from the light guide module of the present invention;

FIG. 9 is an enlarged perspective view showing a wiring hole is provided on the light emitting assembly for the light guide module of the present invention;

FIG. 10 is a sectioned side view showing a plurality of the light guide modules of the present invention are connected in series;

FIG. 11 is an assembled perspective view of a light guide module according to a second preferred embodiment of the present invention;

FIG. 12 is a cross sectional view of FIG. 11;

FIG. 13 is a flowchart showing the steps included in a method of manufacturing the light guide module of the present invention;

FIG. 14 is a flowchart showing the steps included in the method of the present invention for producing the light guide member and the reflector of the light guide module through vacuum suction forming; and

FIG. 15 is a flowchart showing the steps included in another method for forming the reflector of the light guide module of the present invention.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

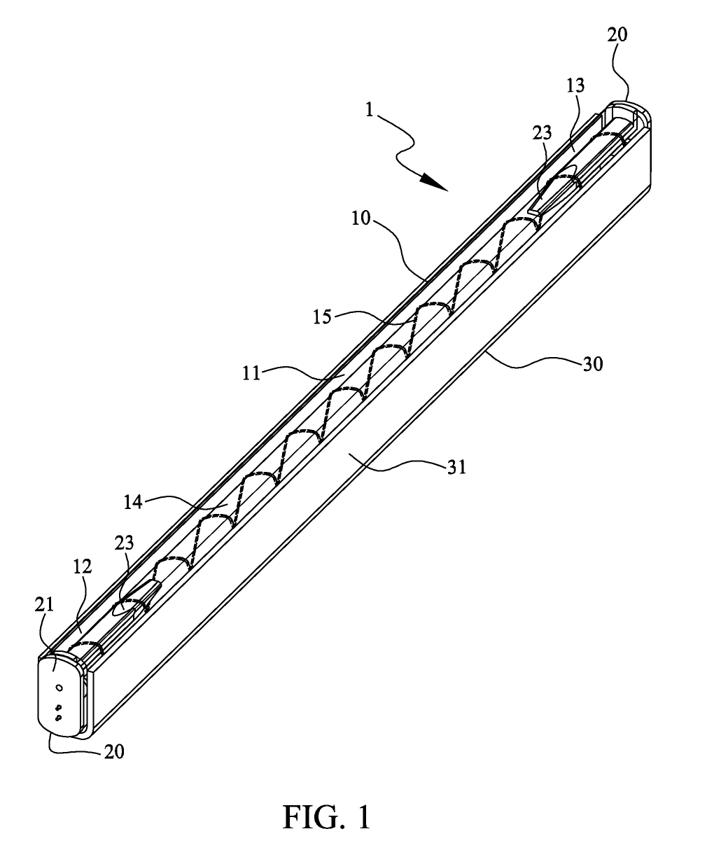

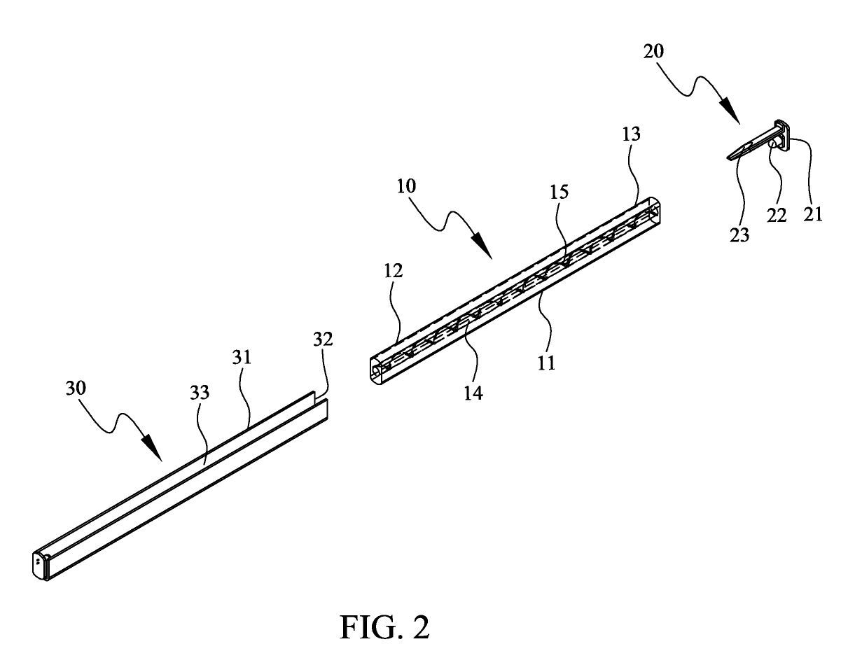

Please refer to FIGS. 1 and 2 that are assembled and exploded perspective views, respectively, of a light guide module 1 according to a first preferred embodiment of the present invention. As shown, the light guide module 1 is a miniaturized light guide module including a light guide member 10, at least one light emitting assembly 20, and a reflector 30. The light guide member 10 is in the form of an elongated bar 11 internally defining a hollow bore 14 axially extended from a first end 12 to an opposite second end 13 of the elongated bar 11. A light-guiding structure 15 is formed in the hollow bore 14 for changing light propagating through the hollow bore 14 to project out of the light guide module in different directions.

The light emitting assembly 20 is provided on at least one of two ends of the elongated bar 11 of the light guide member 10. In the illustrated first preferred embodiment, two light emitting assemblies 20 are separately provided on the first and the second end 12, 13 of the elongated bar 11 of the light guide member 10. Each of the light emitting assemblies 20 includes a circuit board 21 having a shape corresponding to a cross-sectional shape of the elongated bar 11. The circuit board 21 is provided on one face adjacent to the end of the elongated bar 11 with a light-emitting unit 22 for emitting light toward the light guiding structure 15 and a light-shielding unit 23 sidewardly extended into part of the hollow bore 14.

The light-emitting unit 22 can include, but not limited to, a light-emitting diode (LED). That is, the light guide module 1 can include two or more light-emitting units 22 or other similar illuminating structure, depending on an actually required luminous intensity.

The reflector 30 includes a reflective plate 31 covering part of an exterior of the light guide member 10 and the light emitting assemblies 20, such that an open side of the reflective plate 31 that does not cover the light guide member 10 and the reflector 30 forms a light projection side via which light is guided outward. In the illustrated first preferred embodiment, the reflective plate 31 is in the form of a substantially U-sectioned channel structure 32 having three sides covering three outer surfaces of the light guide member 10 and the light emitting assemblies 20 and a fourth side formed into an opening 33 to serve as the light projection side.

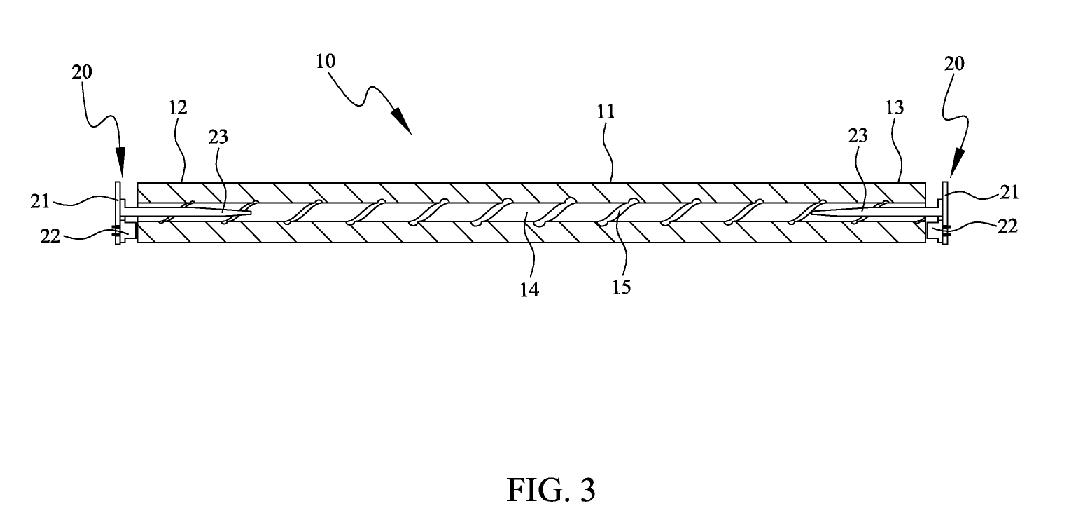

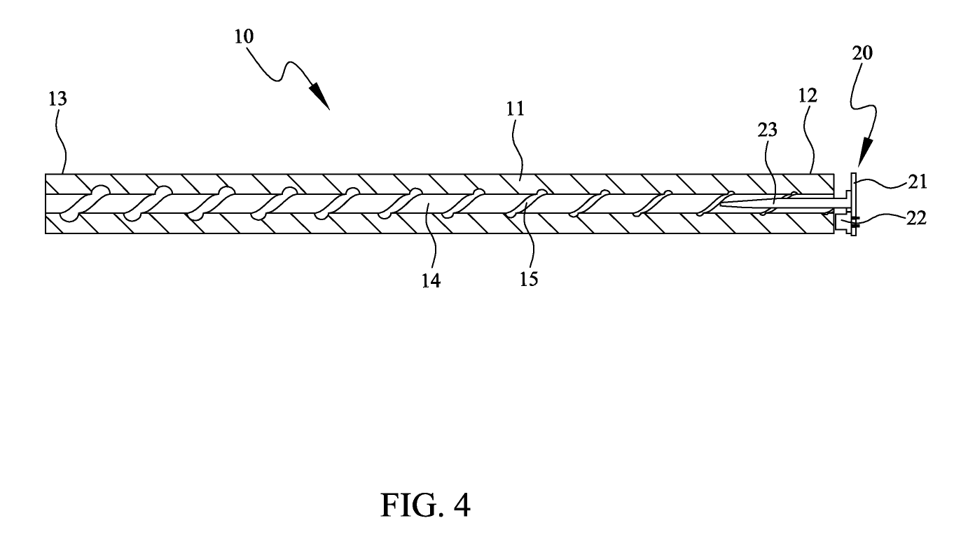

Please refer to FIG. 3. The light-guiding structure 15 can be in the form of a destructive notch internally spirally extended through the elongated bar 11 from one end to the other end thereof. In the case two light emitting assemblies 20 are separately provided on the two opposite ends of the light guide member 10 of the light guide module 1, the destructive notch has a depth gradually increasing from the two ends of the elongated bar 11 toward a middle portion thereof. In the case the light guide member 10 has only one light emitting assembly 20 provided at, for example, the first end 12 thereof, as shown in FIG. 4, the destructive notch shall have a depth gradually increasing from the first end 12 toward the second end 13 of the elongated bar 11, so that light source from the single light emitting assembly 20 can be guided to project outward from the light guide member 10 at even light intensity.

In addition, for the destructive notch to achieve the effect of forming light having even luminous intensity, the spirally extended notch can be designed to have fixed pitch or variable pitch. The size of the pitch is determined according to the luminance of the light-emitting units 22 and the length of the elongated bar 11 of the light guide member 10.

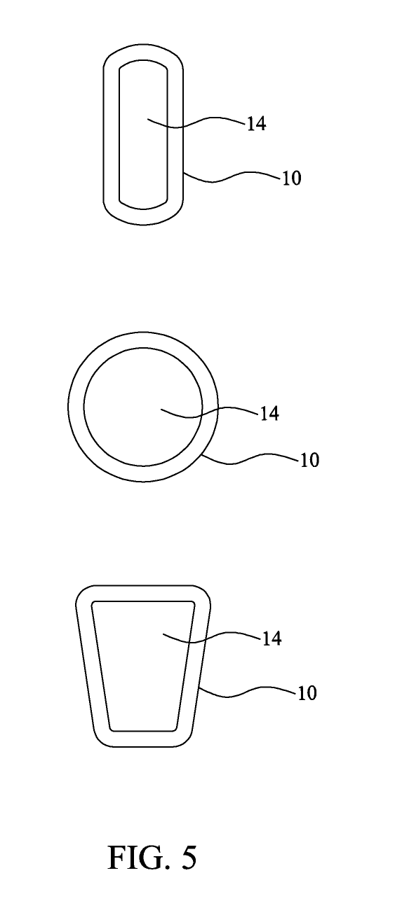

As can be seen in FIG. 5, according to a use's need, the elongated bar 11 of the light guide member 10 can be designed to have a cross section in different geometrical shapes, such as a round, a square, a rectangular, a trapezoidal, an oblong, a pyramid or a polygonal shape. Accordingly, the hollow bore 14 can also be designed to have a cross section in different geometrical shapes, such as a round, a square, a rectangular, a trapezoidal, an oblong, a pyramid or a polygonal shape.

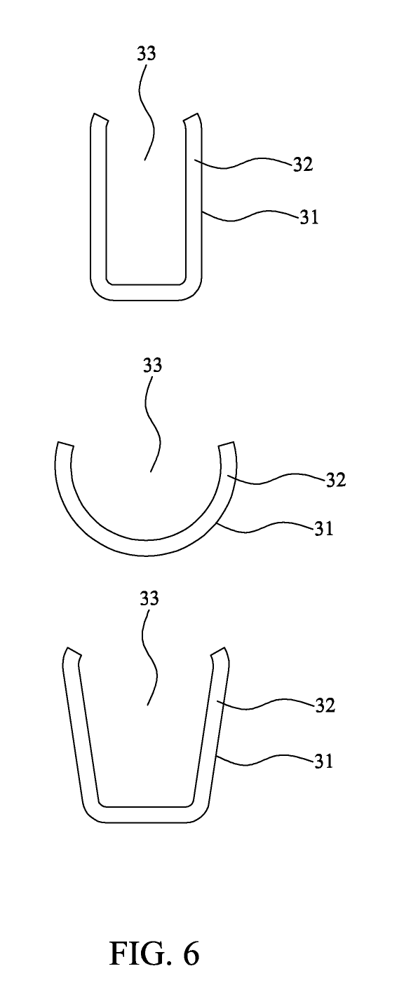

Please refer to FIG. 6. The reflective plate 31 can have a cross-sectional shape corresponding to that of the elongated bar 11, including but not limited to a right-angled “U” shape, a rounded “U” shape, a “V” shape, or a trapezoidal shape. Of course, the elongated bar 11 of the light guide member 10, the hollow bore 14, and the reflective plate 31 of the reflector 30 can also have some special cross-sectional shapes combining two or more different geometrical shapes.

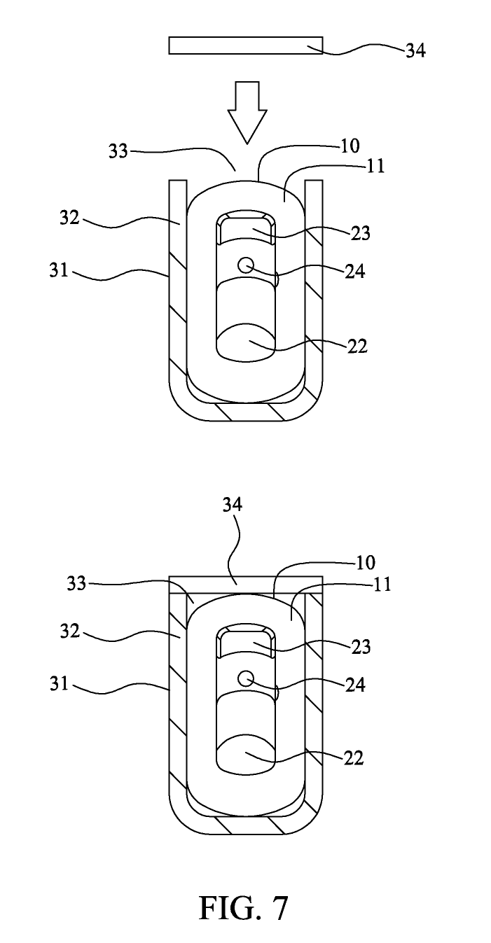

As shown in FIG. 7, a light-transmitting plate 34 can be further provided for attaching to a top of the substantially U-sectioned channel structure 32 to cover the opening 33 of the reflective plate 31. The light-transmitting plate 34 seals the whole light guide module 1, so that the light guide module 1 is waterproof.

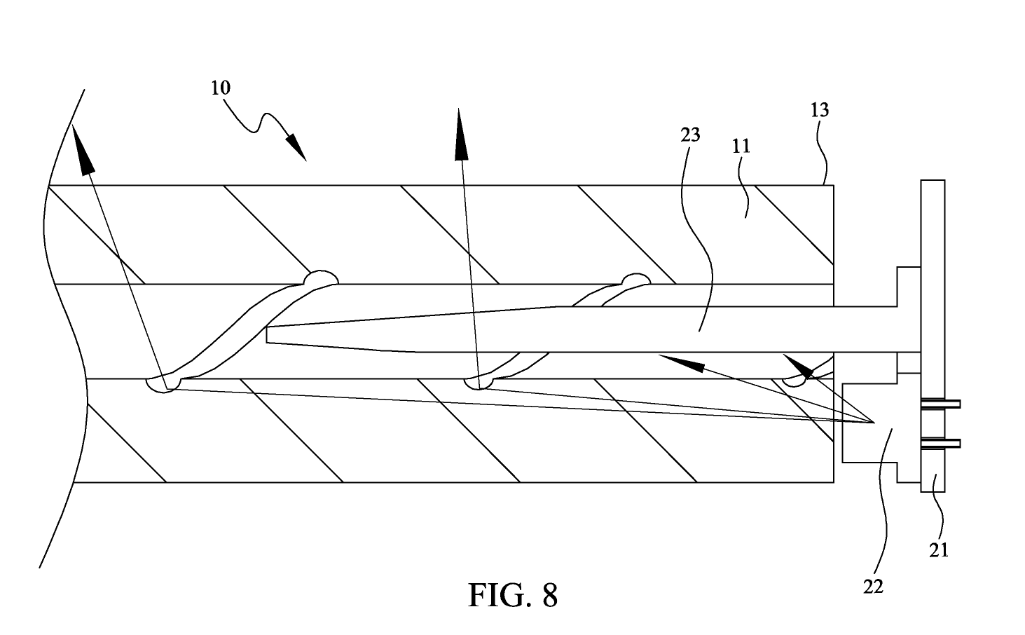

Please refer to FIG. 8. In the present invention, when the light-emitting units 22 emit light toward the elongated bar 11, part of the emitting light is absorbed by the light-shielding units 23 located at two ends of the elongated bar 11 (only one is shown in FIG. 8). Other part of the emitted light propagates toward the middle portion of the elongated bar 11, in the case of having two light-emitting units 23; or toward the other end of the elongated bar 11, in the case of having only one light-emitting unit 23. With the gradually increased depth of the spirally extended destructive notch, the light guiding efficiency of the light guide member 10 at the middle portion or at the other end thereof can be enhanced, enabling the light to project outward from the light guide module 1 at uniform light intensity.

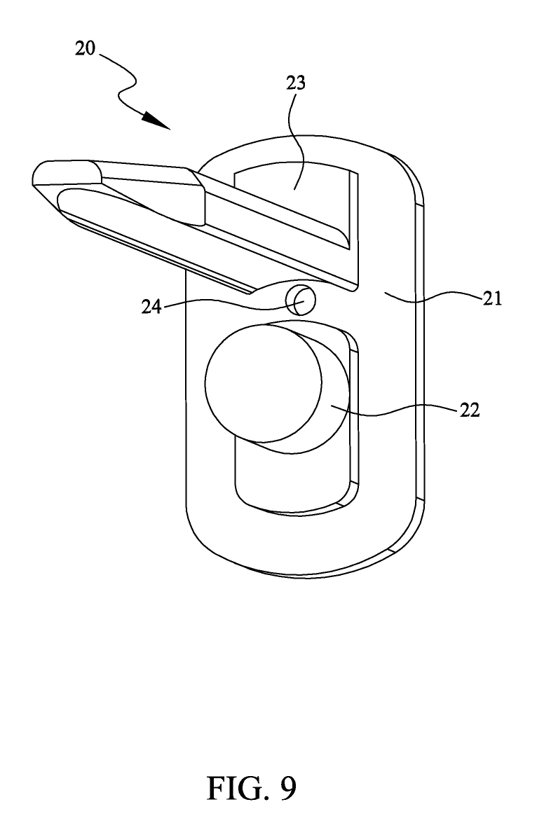

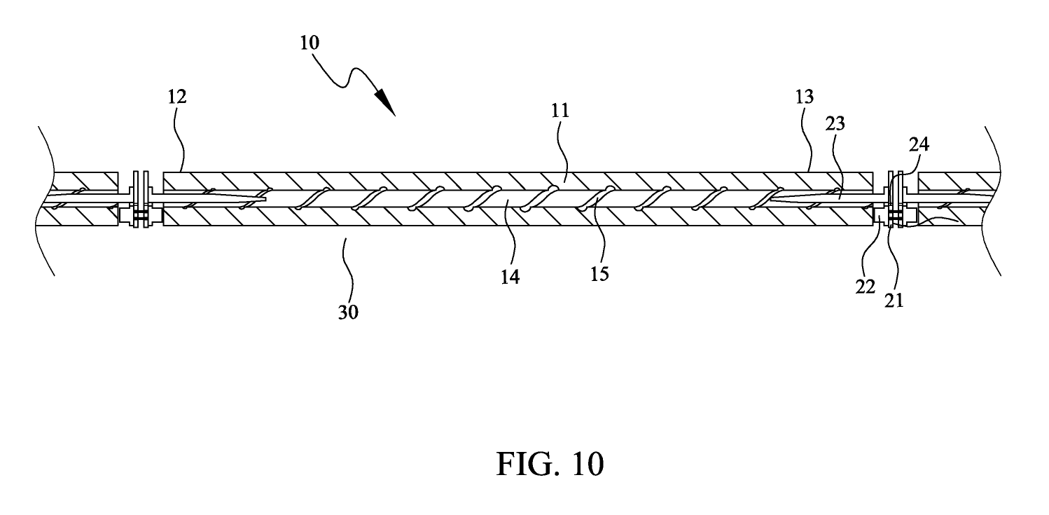

Please refer to FIGS. 9 and 10. To meet the need for a relatively longer light guide module 1, the circuit board 21 of each of the light emitting assemblies 20 is further provided at a central portion with a wiring hole 24 communicating with the hollow bore 14 in the elongated bar 11, so that the circuit board 21 located at one end of the light guide member 10 can be connected to the circuit board 21 located at the opposing end by wires extended through the wiring holes 24. And, a plurality of adjoining light guide modules 1 of the present invention can be serially connected by extending multiple wires through the wiring holes 24 and the hollow bores 14 to electrically connect the circuit boards 21 on these light guide modules 1 to one another in series, so that a length-increased light guide module 1 can be provided to satisfy the user's requirement.

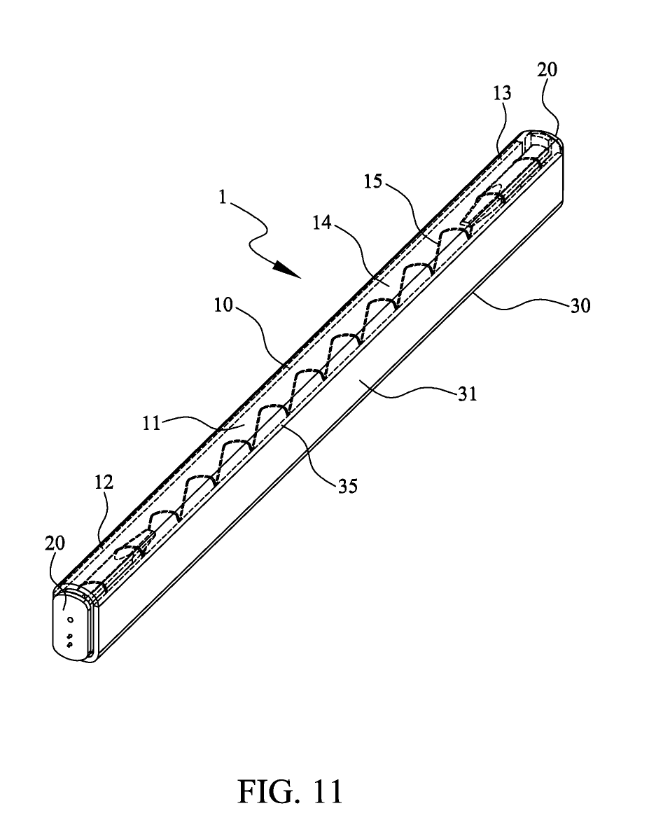

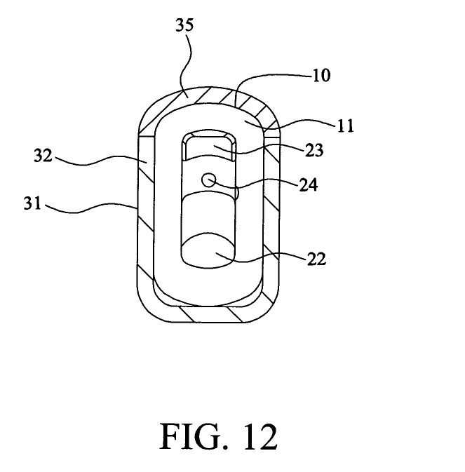

FIGS. 11 and 12 are assembled perspective and cross-sectional views, respectively, of a light guide module 1 according to a second preferred embodiment of the present invention. The second embodiment is structurally similar to the first embodiment, except that the reflective plate 31 further includes a light-transmitting structure 35 integrally formed on a top of the substantially U-sectioned channel structure, so that light can be guided out of the light guide module 1 via the light-transmitting structure 35. Again, the integrally formed light-transmitting structure 35 can have a cross-sectional shape corresponding to that of the light guide member 10.

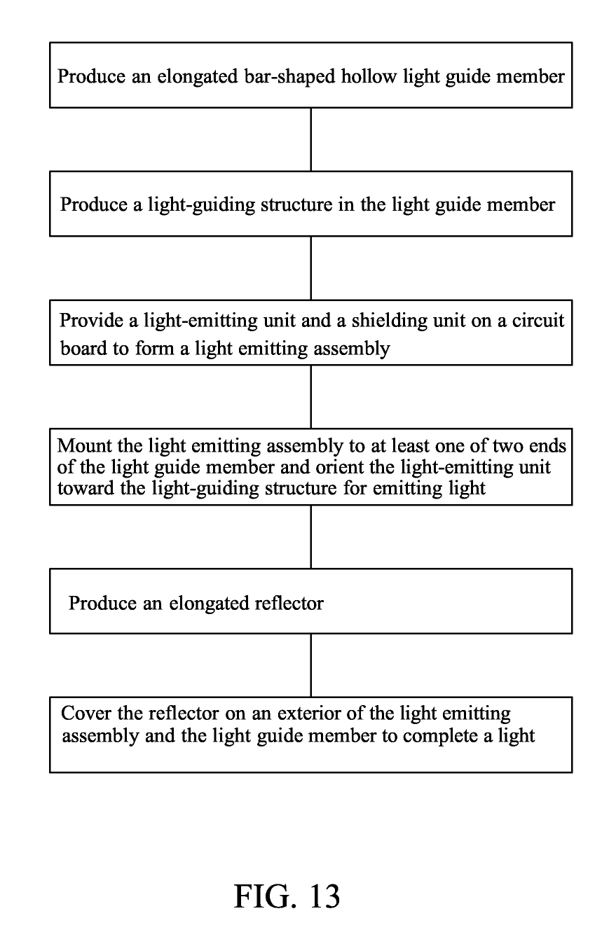

The present invention also provides a method of manufacturing the above-described light guide module 1. FIG. 13 is a flowchart showing the steps included in the light guide module manufacturing method of the present invention. First, an elongated bar-shaped light guide member 10 is produced. Then, produce a light-guiding structure 15 in the light guide member 10; and provide a light-emitting unit 22 and a light-shielding unit 23 on a circuit board 21 to form a light emitting assembly 20. Thereafter, mount the light emitting assembly 20 to at least one of two ends of the light guide member 10 and orient the light-emitting unit 22 toward the light-guiding structure 15 for emitting light. Then, produce an elongated reflector 30; and cover the reflector 30 on an exterior of the light emitting assembly 20 and the light guide member 10 to complete a light guide module 1 having a light projection side. It is noted the above steps for producing the light guide member 10, the light emitting assembly 20 and the reflector 30 can be exchanged in the sequence thereof.

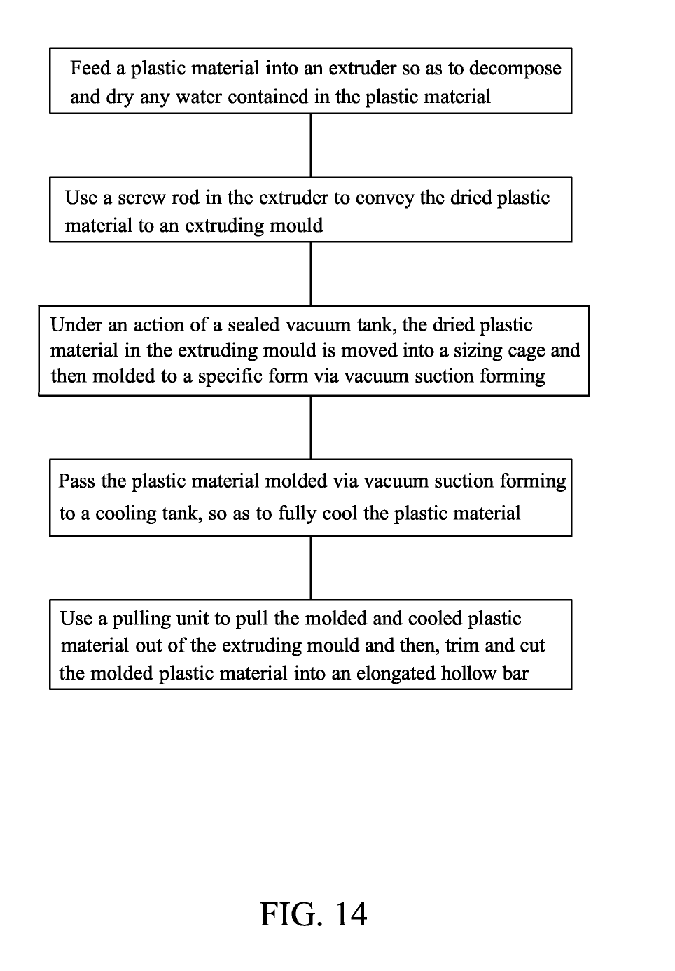

In the present invention, the light guide member 10 and the reflector 30 are produced using an extruder via vacuum suction forming. Please refer to FIG. 14, which is a flowchart showing the steps included in the vacuum suction forming. First, feed a plastic material into the extruder so as to decompose and dry any water contained in the plastic material. Then, use a screw rod in the extruder to convey the dried plastic material to an extruding mould. Under an action of a sealed vacuum tank, the dried plastic material in the extruding mould is moved into a sizing cage and is then molded to a specific form via vacuum suction forming. Then, pass the plastic material molded via vacuum suction forming to a cooling tank, so as to fully cool the plastic material. Finally, use a pulling unit to pull the molded and cooled plastic material out of the extruding mould and then, trim and cut the molded plastic material into an elongated bar.

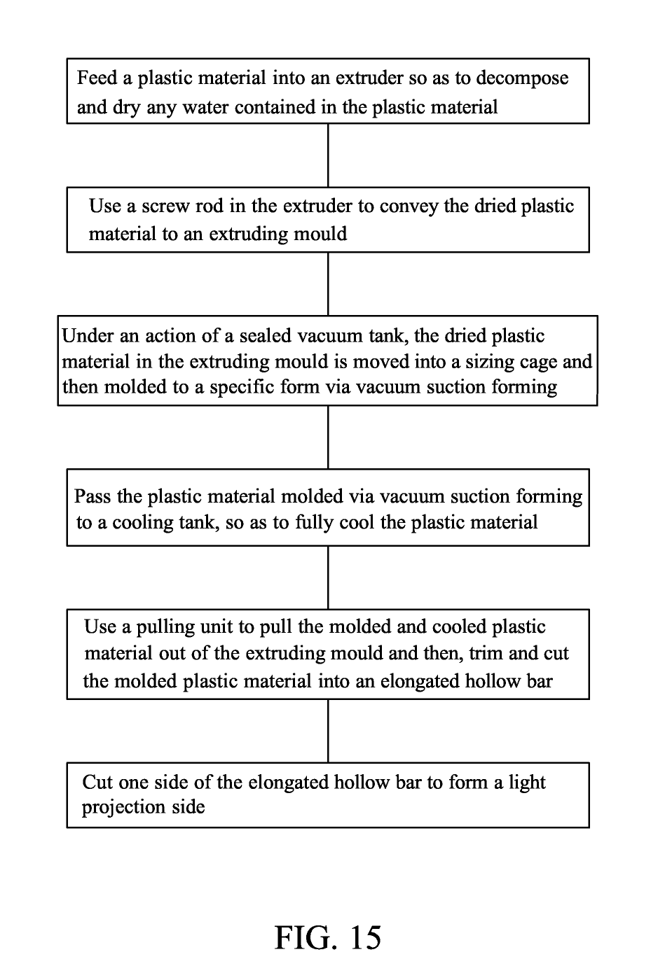

According to another preferred embodiment of the present invention, the reflector 30 can also be produced through vacuum suction forming via the steps shown in FIG. 15. First, feed a plastic material into the extruder so as to decompose and dry any water contained in the plastic material. Then, use a screw rod in the extruder to convey the dried plastic material to an extruding mould. Under an action of a sealed vacuum tank, the dried plastic material in the extruding mould is moved into a sizing cage and is then molded to a specific form via vacuum suction forming. Then, pass the plastic material molded via vacuum suction forming to a cooling tank, so as to fully cool the plastic material. Thereafter, use a pulling unit to pull the molded and cooled plastic material out of the extruding mould and then, trim and cut the molded plastic material into an elongated bar-shaped product. Finally, cut one side of the reflector 30 to form an opening structure, so that the opening structure serves as the light projection side of the reflector 30.

In the above embodiment of the present invention, the light-guiding structure 15 is produced in the light guide member 10 by way of laser engraving or printing; and the reflector 30 formed via the vacuum suction forming is a dual-structure elongated hollow bar. In addition, the light guide member 10 can be further formed into other special geometric shapes by way of hot press molding, so that the light-guiding structure is also molded into a geometric shape.

In another embodiment of the present invention, the reflector 30 has one side formed into a light transmitting structure and another three sides formed into a light reflecting structure, so that the light transmitting structure serves as a light projection side of the reflector 30.

In brief, according to the light guide module of the present invention and the manufacturing method thereof, two light emitting assemblies can be provided to two ends of the light guide member for emitting light toward the spirally extended destructive notch in the light guide member, and the reflector covers three sides of the light guide member and the light emitting assembly with an open side of the reflector serving as a light projection side. With these arrangements, a miniaturized light guide module is formed. Further, with the light-shielding units of the light emitting assemblies extended into two end portions of the light guide member, the light source emitted from the light emitting assemblies toward the light guide member can be guided to project outward via the light projection side of the light guide module at even luminous intensity. Therefore, the problem in the conventional light guide module of having high luminous intensity at two ends and low luminous intensity at a middle portion of the light guide module can be effectively improved.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A light guide module, comprising:
a light guide member being in the form of an elongated bar, the elongated bar being internally provided with a hollow bore extended from a first end to an opposing second end of the elongated bar, and a light-guiding structure being provided in the hollow bore for changing light propagating through the hollow bore to different projection directions;
at least one light emitting assembly being mounted to at least one of the two ends of the elongated bar of the light guide member; the light emitting assembly including a circuit board shaped corresponding to a cross-sectional shape of the elongated bar, at least one light-emitting unit provided on one face of the circuit board adjacent to the end of the elongated bar for emitting light toward the light-guiding structure, and a light-shielding unit sidewardly extended into part of the hollow bore; and
a reflector including a reflective plate for covering part of an exterior of the light guide member and the light emitting assembly, and one side of the reflective plate that does not cover the light guide member and the reflector forming a light projection side via which light is guided outward.

2. The light guide module as claimed in claim 1, wherein the reflective plate is in the form of a substantially U-sectioned channel structure having three sides covering three outer surfaces of the light guide member and the light emitting assembly and a fourth side forming into an opening to serve as the light projection side.

3. The light guide module as claimed in claim 2, wherein the reflector further includes a light-transmitting structure being integrally formed with the substantially U-sectioned channel structure of the reflective plate at the opening thereof.

4. The light guide module as claimed in claim 2, wherein the reflector further includes a light-transmitting plate being attached to a top of the substantially U-sectioned channel structure to cover the opening of the reflective plate.

5. The light guide module as claimed in claim 1, wherein the circuit board is further provided at a central portion with a wiring hole communicating with the hollow bore in the elongated bar of the light guide member.

6. The light guide module as claimed in claim 1, wherein the light-guiding structure is in the form of a destructive notch spirally extended through the hollow bore.

7. The light guide module as claimed in claim 6, wherein the destructive notch has a depth gradually increasing from the first and the second end of the elongated bar toward a middle portion thereof.

8. The light guide module as claimed in claim 6, wherein the destructive notch has a depth gradually increasing from the first end toward the second end of the elongated bar.

9. The light guide module as claimed in claim 6, wherein the spirally extended destructive notch has a pitch selected from the group consisting of fixed pitch and variable pitch.

10. The light guide module as claimed in claim 1, wherein the elongated bar has a cross section in a geometrical shape selected from the group consisting of round, square, rectangular, oval, pyramid and polygonal shapes and any combination thereof.

11. A method of manufacturing a light guide module as claimed in claim 1, comprising the following steps:
producing an elongated bar-shaped light guide member;
producing a light-guiding structure in the light guide member;
providing a light-emitting unit and a light-shielding unit on a circuit board to form a light emitting assembly;
mounting the light emitting assembly to at least one of two ends of the light guide member and orienting the light-emitting unit toward the light-guiding structure for emitting light;
producing an elongated reflector; and
covering the reflector on an exterior of the light emitting assembly and the light guide member to complete a light guide module.

12. The light guide module manufacturing method as claimed in claim 11, wherein the light guide member and the reflector are produced using an extruder through vacuum suction forming.

13. The light guide module manufacturing method as claimed in claim 12, wherein the vacuum suction forming includes the following steps:
feeding a plastic material into the extruder so as to decompose and dry any water contained in the plastic material;
using a screw rod in the extruder to convey the dried plastic material to an extruding mould;
under an action of a sealed vacuum tank, the dried plastic material in the extruding mould being moved into a sizing cage and then molded to a specific form via vacuum suction forming;
passing the plastic material molded via vacuum suction forming to a cooling tank, so as to fully cool the plastic material; and
using a pulling unit to pull the molded and cooled plastic material out of the extruding mould and then, trimming and cutting the molded plastic material into an elongated bar.

14. The light guide module manufacturing method as claimed in claim 13, wherein the reflector produced through the vacuum suction forming is cut at one side to form an opening, so that the opening serves as a light projection side of the reflector.

15. The light guide module manufacturing method as claimed in claim 13, wherein the reflector produced through the vacuum suction forming is a dual-structure elongated hollow bar with one side thereof formed into a light-transmitting structure and another three sides thereof formed into a light-reflecting structure, and the light-transmitting structure forming a light projection side of the reflector.

16. The light guide module manufacturing method as claimed in claim 12, wherein the light guide member is further processed by hot press molding, so that the elongated bar thereof has a cross section in a specific geometrical shape.

17. The light guide module manufacturing method as claimed in claim 12, wherein the light-guiding structure is produced on the light guide member in a manner selected from the group consisting of laser engraving and printing.

18. The light guide module manufacturing method as claimed in claim 12, wherein the light-guiding structure is produced on the light guide member by hot press molding to have a geometrical shape.
